(19) United States
(12) Patent Application Publication
(10) Pub. No.: US 2022/0152431 A1
(43) Pub. Date: May 19, 2022

(54) Hood For Powered Air Purifying Respirator

(71) Applicant: United States Government as Represented by the Department of Veterans Affairs, Washington, DC (US)

(72) Inventors: Joseph Iaquinto, Seattle, WA (US); Alexander Berardo-Cates, Seattle, WA (US); Arrianna Willis, Seattle, WA (US); Darren Li, Seattle, WA (US)

(21) Appl. No.: 17/530,558

(22) Filed: Nov. 19, 2021

Related U.S. Application Data
(60) Provisional application No. 63/115,900, filed on Nov. 19, 2020.

(51) Int. Cl. A62B 17/04; A62B 17/00; A41D 13/11

(52) U.S. Cl. CPC A62B 17/04; A62B 17/006; A62B 17/001; A41D 2200/20; A41D 2300/32; A41D 2500/52; A41D 13/1153

(57) ABSTRACT

A respiratory device for covering a head of a wearer can comprise a head engagement element. A hood can define an interior and a rim. The hood can comprise a rim that is configured to bias against the head of the wearer to inhibit air communication therebetween. At least a portion of the hood can be transparent. A hose fitting can be operatively coupled to the hood to provide air therethrough into the interior of the hood. The hood can be configured to be releasably coupled to the head engagement element at a plurality of positions. The plurality of positions can comprise a forward position and a rear position that is spaced from the forward position by at least one inch along an anteroposterior adjustment axis.

### CROSS-REFERENCE TO RELATED APPLICATIONS

This application claims priority to and the benefit of the filing date of U.S. Provisional Patent Application No. 63/115,900, filed Nov. 19, 2020, the entirety of which is hereby incorporated by reference herein.

### FIELD

This disclosure relates to head coverings for supplying purified air to a wearer. In some exemplary aspects, this disclosure relates to hoods for powered air purifying respirators.

### BACKGROUND

Powered air purifying respirator (PAPR) hoods are commonly used in hazardous environments such as industrial or medical facilities. PAPR hoods are typically designed to work in conjunction with a respirator to deliver filtered air to the wearer using positive pressure to ensure that non-filtered air does not enter the airway of the wearer.

Conventional PAPR hoods are usually disposable and otherwise difficult or impossible to clean and disinfect for reuse. Accordingly, a reusable, disinfectable PAPR hood is desirable.

Additionally, conventional PAPR hoods are configured to mate with a particular (e.g., a single) type of PAPR hose coupling. Accordingly, conventional PAPR hoods cannot be coupled to other (e.g., multiple types of) hose couplings.

Still further, PAPR hoods are conventionally made of materials that are used in various other medical devices (e.g., surgical gowns). For this reason, during times in which these materials are in high demand, they can be unavailable or difficult to obtain. Accordingly, it is desirable to limit or eliminate materials that are used in other equipment of the same industry that would otherwise compete for material availability, particularly in times of high demand, such as during a pandemic.

### SUMMARY

Disclosed herein, in one aspect, is a respiratory device for covering at least a portion of a head of a wearer. The respiratory device can comprise a head engagement element. A hood can define an interior. The hood can comprise a rim that is configured to bias against the head of the wearer to inhibit air communication therebetween the rim and the head of the wearer. At least a portion of the hood can be transparent. A hose fitting can be operatively coupled to the hood to provide air therethrough into the interior of the hood. The hood can be configured to be releasably coupled to the head engagement element at a plurality of positions. The plurality of positions can comprise a forward position and a rear position that is spaced from the forward position by at least one inch along an anteroposterior adjustment axis.

In another aspect, a respiratory device can be configured to cover at least a portion of a head of a wearer. The respiratory device can comprise a hood defining an inner surface, an outer surface, and an interior. The hood can be configured to bias against the head of the wearer to inhibit air communication therebetween the hood and the head of the wearer. A hose fitting can be operatively coupled to the hood to provide air therethrough into the interior of the hood. The hood can define a hole through which the hose fitting extends. The hose fitting can comprise a hose adapter having a first end and an axially opposed second end, the hose adapter comprising: an inner bore extending between the first and second end; a cylindrical exterior surface that extends from the first end; a flange at the first end; and a radially extending projection that is spaced from the first end and extends from the cylindrical exterior surface. The second end of the hose adapter can be configured to couple to a corresponding hose fitting of an air supply hose. A locking sleeve can comprise an annular body having a rear end and a cylindrical inner surface that is configured to receive the cylindrical exterior surface of the hose adapter. The annular body can define a slot therein. The slot can comprise a first end that extends to the forward end of the hollow axial protrusion, a second end that is axially and rotationally offset from the first end, and an axially extending lip that is positioned between the first end and the second end. With the cylindrical exterior surface of the hose adapter received within the cylindrical inner surface of the locking sleeve and the radially extending protrusion of the hose adapter extending into the slot of the locking sleeve, the flange of the hose adapter can bias against the inner surface of the hood, and the rear end of the annular body can bias against the outer surface of the hood.

Disclosed herein, in further aspects, is a respiratory device for covering at least a portion of a head of a wearer. The respiratory device can comprise a head engagement element. A hood defining an interior and a rim. The hood can comprise a rim that is configured to bias against the head of the wearer to inhibit air communication therebetween. At least a portion of the hood can be transparent. A hose fitting can be operatively coupled to the hood to provide air therethrough into the interior of the hood. The hood can comprise a material that is configured to be disinfected and reused. The hood can comprise an elastic member that extends along the rim of the hood. The elastic member can be fully sealed within a polymer housing.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

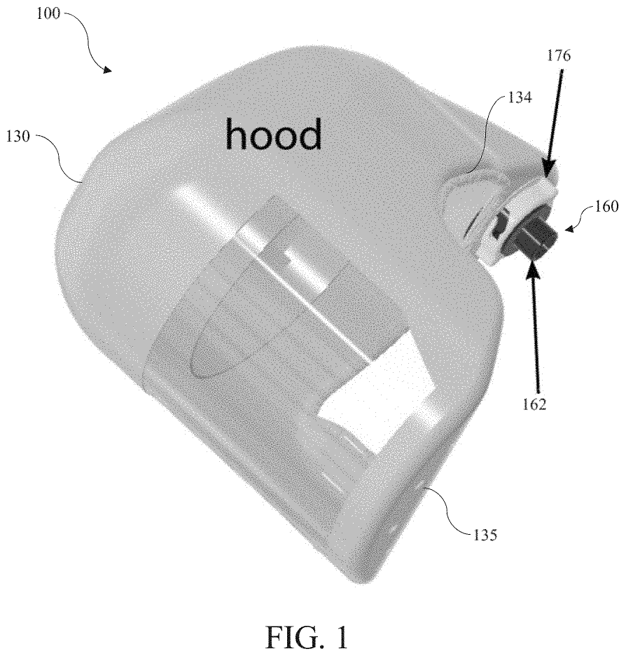

FIG. 1 is a perspective view of a respiratory device in accordance with embodiments disclosed herein.

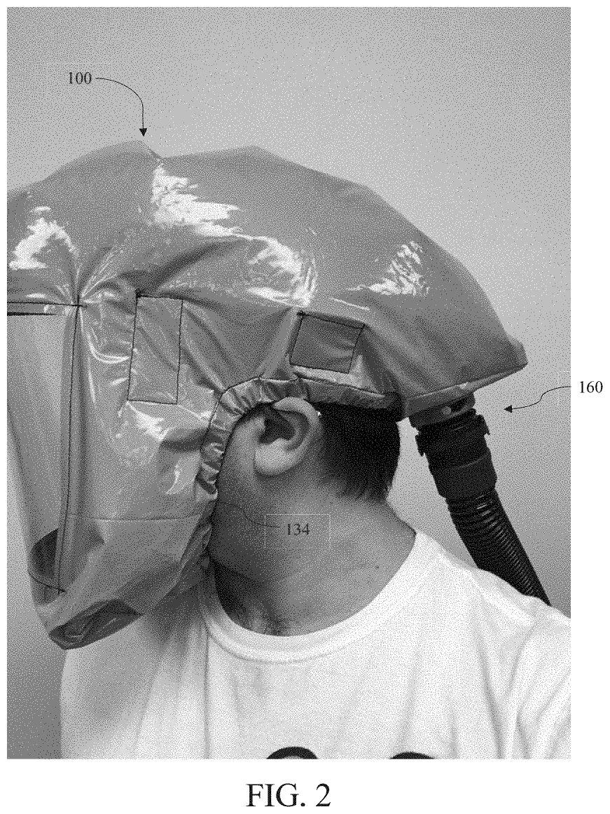

FIG. 2 is a side view of the respiratory device of FIG. 1 worn on a wearer.

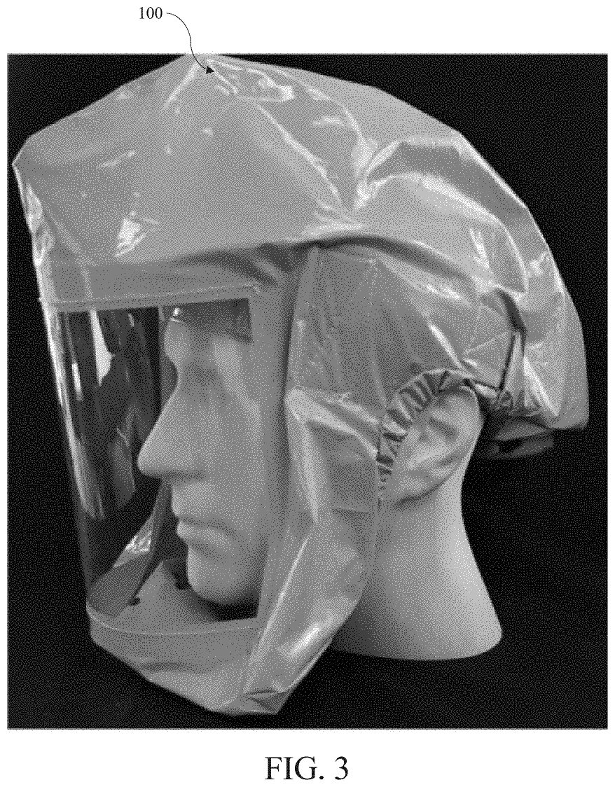

FIG. 3 is a front-side view of the respiratory device of FIG. 1 on a headform.

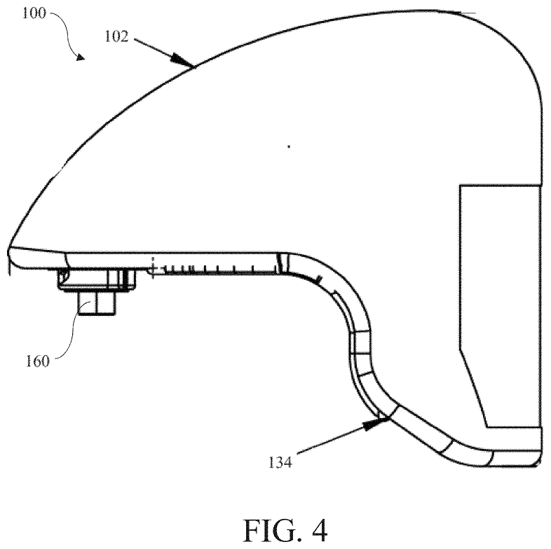

FIG. 4 is a side view of the respiratory device of FIG. 1.

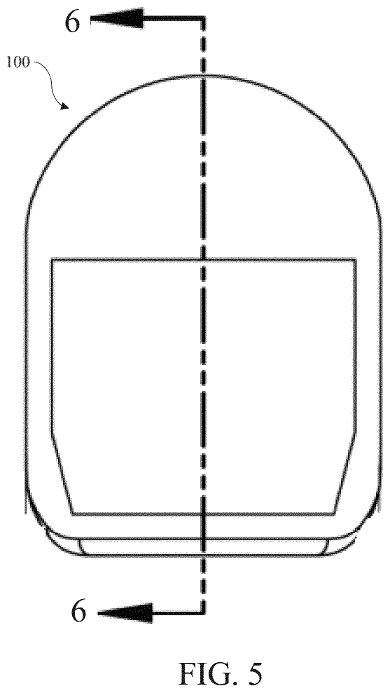

FIG. 5 is a front view of the respiratory device of FIG. 1.

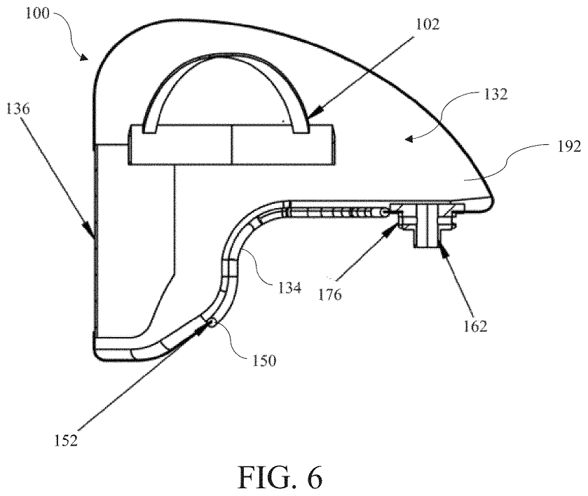

FIG. 6 is a cross sectional view of the respiratory device taken in the plane 6-6 in

FIG. 5.

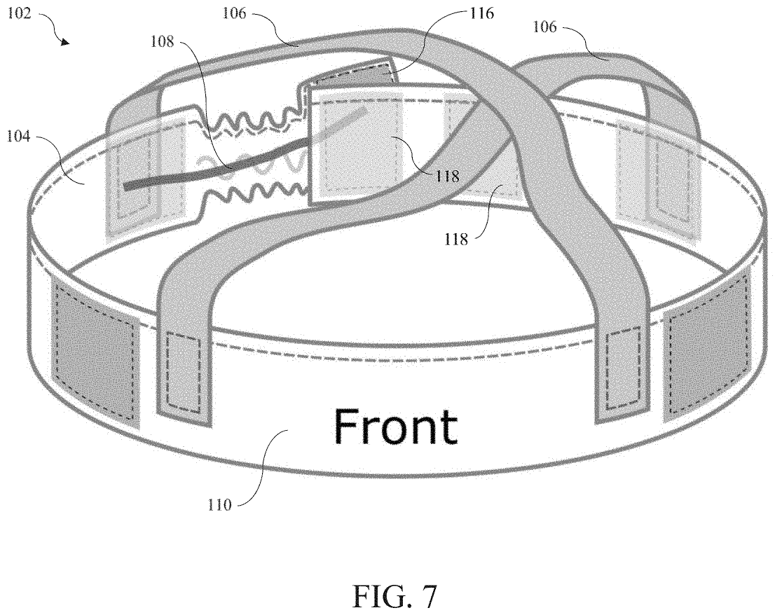

FIG. 7 is a perspective view of a head engagement element of the respiratory device of FIG. 1.

FIG. 8 is a rear view of the head engagement element on a small headform.

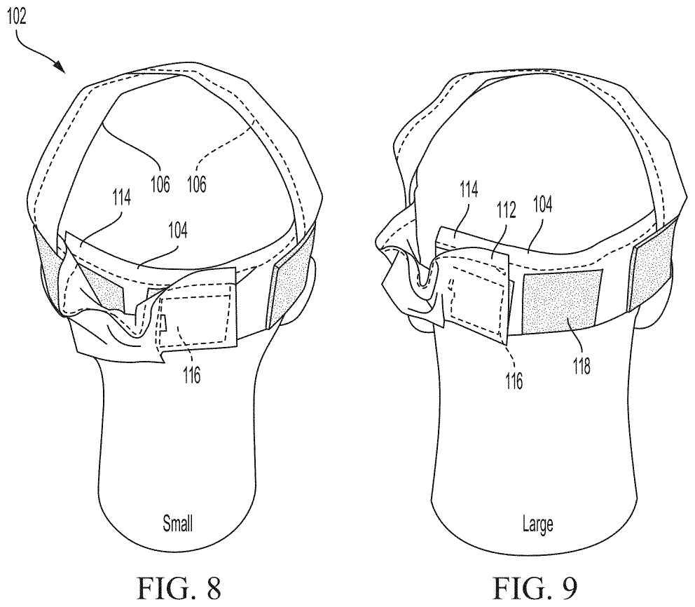

FIG. 9 is a rear view of the head engagement element on a large headform.

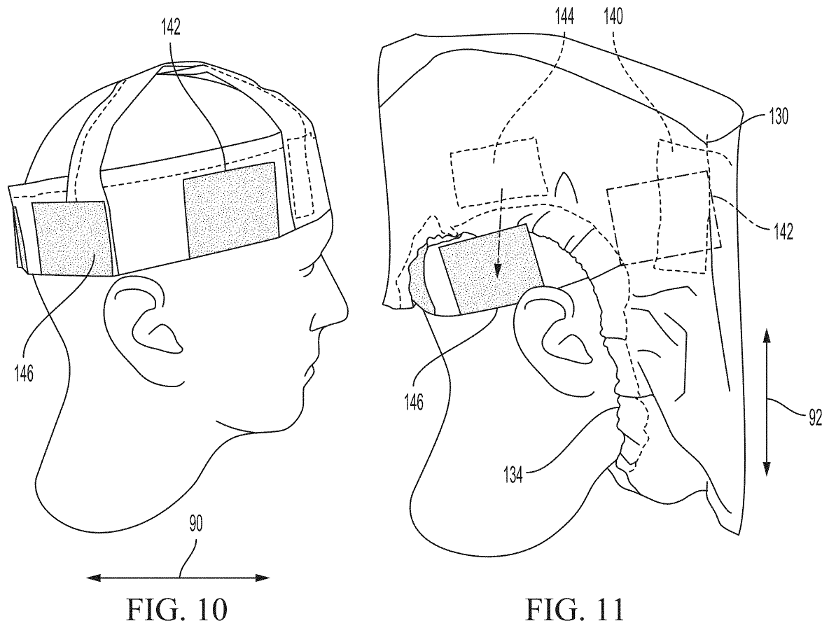

FIG. 10 is a side view of the head engagement element on a headform.

FIG. 11 is a side view of the head engagement element as in FIG. 10 with a hood partially coupled thereto.

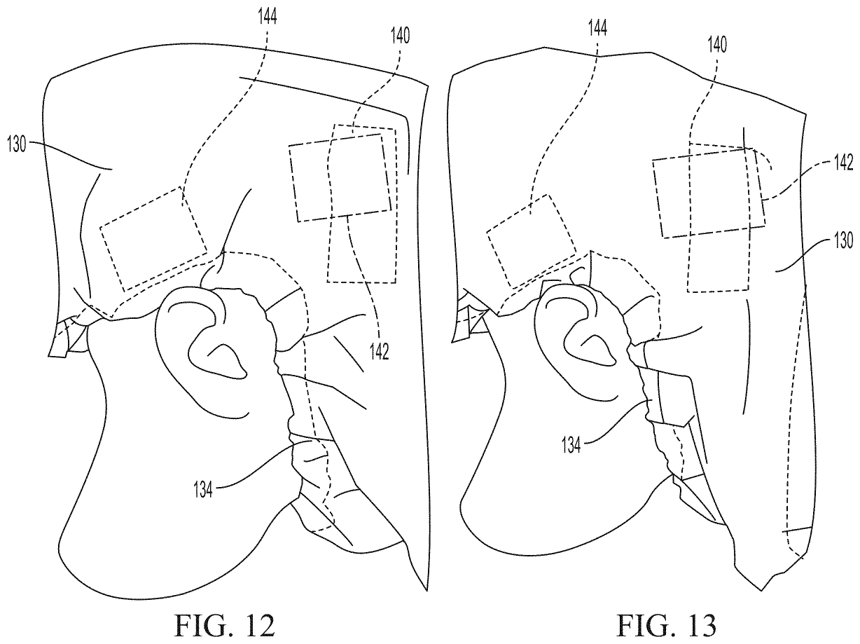

FIG. 12 is a side view of the head engagement element and hood fully coupled thereto in a first position.

FIG. 13 is a side view of the head engagement element and hood fully coupled thereto, wherein the hood is a second position that is rearwardly positioned relative to the first position.

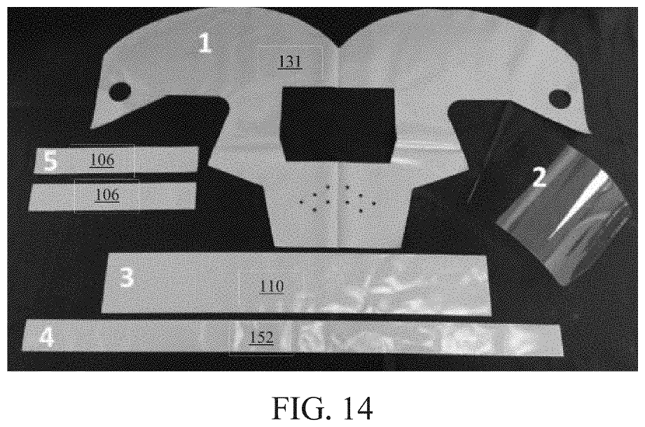

FIG. 14 is a top view of materials for forming the respiratory device of FIG. 1.

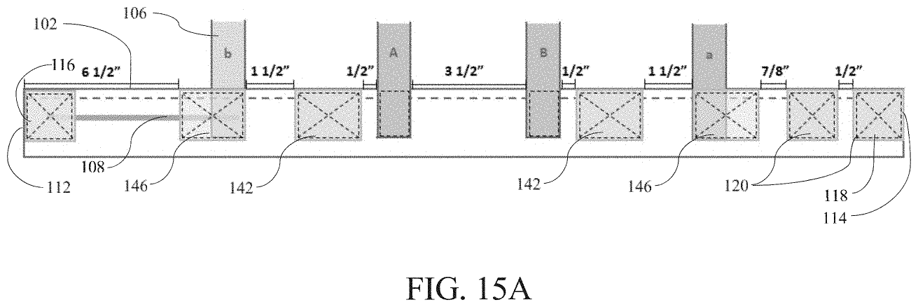

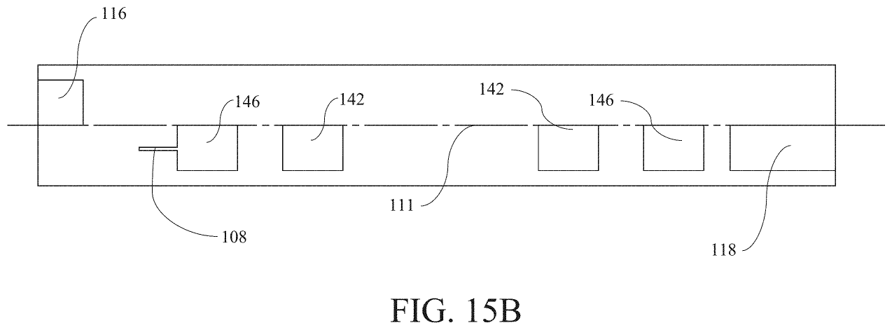

FIG. 15A is a side view of the head engagement element as in FIG. 7 in an elongate configuration and showing exemplary, optional dimensions. FIG. 15B illustrates a side view of a looped band of the head engagement element prior to folding along a folding line.

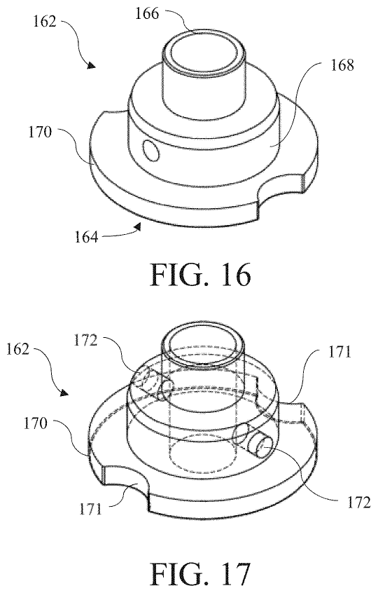

FIG. 16 is a perspective view of a hose adapter.

FIG. 17 is a transparent perspective view of the hose adapter of FIG. 16 with radially extending projections.

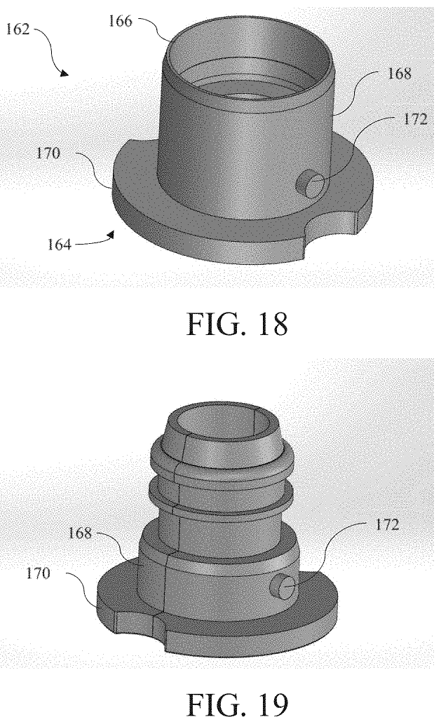

FIG. 18 is a perspective view of another hose adapter.

FIG. 19 is a perspective view of yet another hose adapter.

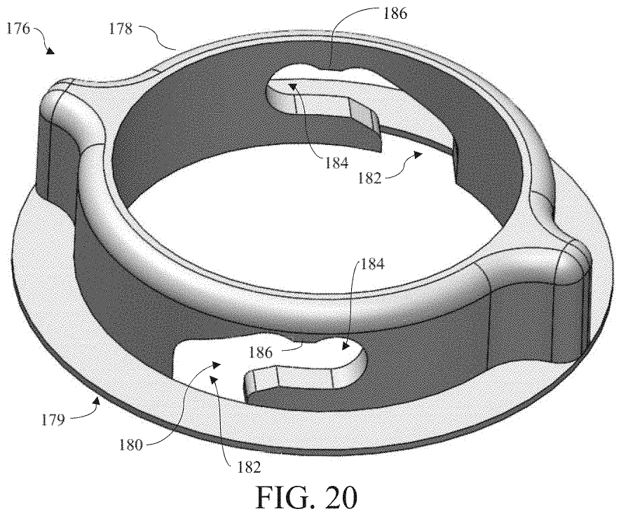

FIG. 20 is a perspective view of a locking sleeve.

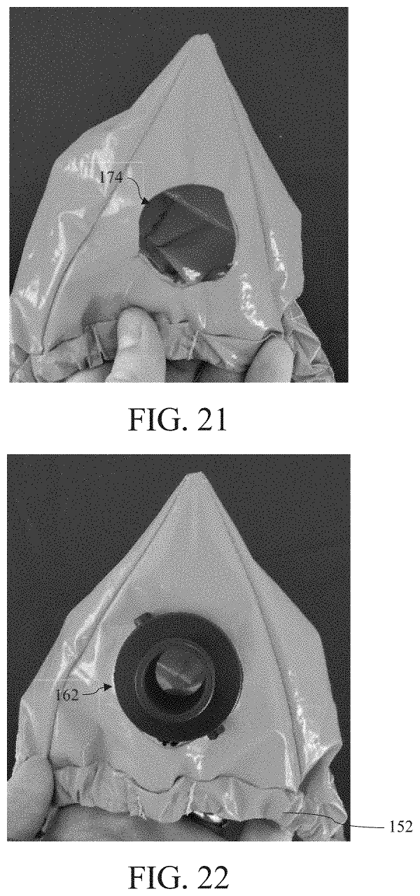

FIG. 21 is an underside view of a rear portion of the hood showing a hole for receiving a hose adapter.

FIG. 22 is the underside view as in FIG. 21 with the hose adapter therein.

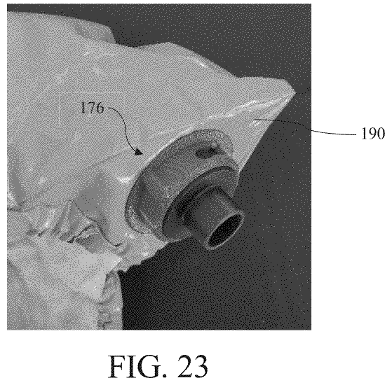

FIG. 23 is an underside view of the rear portion of the hood with the locking ring retaining the hose adapter within the hole in the hood.

### DETAILED DESCRIPTION

The present invention can be understood more readily by reference to the following detailed description, examples, drawings, and claims, and their previous and following descriptions. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a slot” can include two or more such slots unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects.

As used herein, the terms “optional” or “optionally” mean that the subsequently described event or circumstance may or may not occur, and that the description includes instances where said event or circumstance occurs and instances where it does not.

The word “or” as used herein means any one member of a particular list and, except where the context indicates otherwise, can also include any combination of members of that list.

It is contemplated that descriptions of complementary fasteners should be understood as disclosing the explicitly disclosed positions as well as the positions of the complementary fasteners in swapped positions. For example, as used herein where a first fastener (e.g., hook material) is disclosed as coupled to a first component, and a second, complementary fastener (e.g., loop material) is disclosed as coupled to a second component that couples to the first component via the first fastener and complementary fastener, it should be understood that a configuration in which the first fastener is coupled to the second component, and the second, complementary fastener is coupled to the first component is also disclosed.

As further disclosed herein, loose fitting, Powered Air Purifying Respirator (PAPR) hoods are devices that are configured to work in conjunction with a respirator to deliver filtered air to the wearer using positive pressure to ensure that non-filtered air does not enter the airway of the wearer.

Disclosed herein, in various aspects and with reference to FIGS. 1-23, is a respiratory device 100. The respiratory device can accept a hose or tubing at the back of the hood via a hose fitting. In various aspects, the hose or tubing can be positioned at a rear portion of the respiratory device. Airflow from the hose or tubing can flow over the head of the user, down the face, and can be vented out of holes under the mouth area.

At least a portion of the hose fitting can be interchangeable to allow for different hose connections to be made and for the hose fitting to be re-used over the life of several hoods. A removable and adjustable headband can allow the user to custom fit the hood to her head and position the material to leave the ears exposed while maintaining a loose seal around the face and neck. The seal can be provided by a polymer-wrapped elastic cord that can allow the hood exterior to be cleaned and disinfected. A clear visor front can provide visibility.

Referring to FIGS. 1, 7, and 15A-B, the respiratory device 100 can comprise a head engagement element 102. In various aspects, the head engagement element 102 can comprise a looped band 104. The head engagement element 102 can further comprise one or more head straps 106 (two shown) that extend between attachment points on opposing sides of the looped band 104. The head straps 106 can be configured to bias against an upper surface (or upper surfaces) of the head of the wearer. In this way, the head straps 106 can both distribute the weight of the respiratory device as well as maintain its vertical position. In exemplary aspects, one or both longitudinal ends 107 of the head straps 106 can couple to the looped band 104 via stitching. In further aspects, one or both longitudinal ends 107 of the head straps 106 can couple to the looped band 104 via hook and loop fastener. In this way, a functional length of the head straps 106 can be adjusted to adjust the position at which the looped band 104 rests on the head of the wearer.

Optionally, at least a portion of the looped band 104 can comprise an elastic material 108 that is configured to reduce an operative circumference of the looped band. For example, in some optional aspects, the elastic material 108 can extend along at least a portion of (optionally, the entirety of) the operative circumference of the looped band 104. In exemplary aspects, the elastic material 108 can be an elastic cord. The elastic material 108 can optionally be positioned within an interior of the looped band. For example, the looped band 104 can comprise a folded sheet of material with the elastic cord or other material disposed within the folded material. The elastic cord can optionally be from about 2 to about 4 inches (e.g., about 3 inches) when unstretched.

In an optional aspect, the looped band 104 can comprise a strip of material 110 (optionally, polymer material) having a length and a width. The strip of material 110 can be folded in half along its width (e.g., at folding line 111, shown in FIG. 15B) and attached (e.g., sewn) at its edges opposing the fold to define an interior that extends along the length of the material 110. A length of elastic material 108 can be inserted within the interior and attached to the material 110 at each end of the elastic material so that the elastic material retracts to reduce the operative circumference of the looped band 104. For example, in a resting position, the elastic material 108 can cause the strip of material 110 to scrunch together (for example, with overlapping folds) to reduce its operative length.

A first longitudinal end portion 112 and a second longitudinal end portion 114 of the strip of material 110 can be coupled to each other to form the looped band. At least one fastener can be configured to couple the first end portion to the second end portion. The at least one fastener can be configured to couple the first end portion to the second end portion in a plurality of positions to permit user selection of an operative circumference of the looped band. For example, optionally, one of a loop material 116 or a hook material 118 can be coupled to the first longitudinal end portion 112 of the strip of material 110, and the other of the loop material 116 or the hook material 118 can be coupled to the second longitudinal end portion 114. Optionally, one of the hook or loop material 118,116 can comprise a plurality of hook or loop material segments 120 that are longitudinally spaced along the length of the strip (prior to formation of the looped band). For example, as illustrated, the head engagement element 102 can comprise two segments 120 of hook material 118 that are longitudinally spaced and offset from each other along the length of the strip of material 110. The segments can be spaced by, for example, from about ¼ inch to about 1 inch (e.g., about ½ inch). In further aspects, at least one of the loop material 116 or the hook material 118 can extend sufficiently longitudinally along the strip of material 110 to allow for couplings with the looped band at different operative circumferences for receiving heads of different sizes. For example, the two illustrated segments 120 can instead be embodied as a single continuous strip, as illustrated in FIG. 15B. In this way, the loop material 116 and the hook material 118 can allow for the operative circumference of the looped band to vary by, for example, at least one inch, at least two inches, or at least three inches, or more. Accordingly, the loop material 116 and the hook material 118 can have sufficient overlap to couple together when the looped band defines a first operative circumference and a second operative circumference that is greater than the first operative circumference.

In further optional aspects, the strip of material 110 can form a loop via various other releasable fasteners (e.g., snaps, magnets, buttons, etc.) or via nonreleasable fasteners (e.g., stitching).

In some optional aspects, the head engagement element 102 can be or can comprise a cap (e.g., an elastic cap). The cap can define an interior space and an opposed exterior, with the interior space being configured to receive at least a portion of the head of the wearer.

The respiratory device 100 can further comprise a hood 130 that is configured to couple to the head engagement element 102. The hood 130 can define an interior 132 that is configured to be positioned over the head of the wearer. The hood 130 can comprise a transparent visor 136. The hood 130 can further comprise a rim 134 that is configured to bias against the head of the wearer to inhibit air communication between the rim and the head. For example, the rim 134 can extend below the chin, along the sides of the face, and around the back of the head of the user. In some aspects, the rim 134 can be positioned forwardly of and above the ears of the wearer so that the ears are not positioned within the interior 132 of the hood 130. That is, the head engagement element 102 can be positioned above the ears and allow the hood 130 to connect to the head engagement element so that the rim 134 is also above (and forward of) the ears, with the hood 130 still being well-supported. In this way, the hood 130 can promote hearing of the wearer and enable use of stethoscopes and other instruments that require ear access. Further, by supporting the hood 130 via the head engagement element 102 and positioning the rim 134 above and forward of the ears, the rim does not rest on the ears, which can cause discomfort over extended periods. Still further, positioning of the rim 134 above and forward of the ears can provide a sealing engagement that inhibits airflow between the rim and the head. The chin elastic tension can be further adjusted to improve the fit around the neck and face, thereby promoting a good seal between the rim and the wearer. The hood 130 can define exhalation holes 135 that are positioned below the chin of the wearer and are configured to allow the air in the hood to purge.

The hood 130 can couple to the head engagement element 102 via a releasable fastener. The head engagement element 102 can support the hood 130 in an elevated position to allow air travel between the hood and the head of the wearer. The hood 130 can be configured to be coupled to the head engagement element 102 in a plurality of positions in order to ensure a proper fit on the wearer. It is contemplated that the plurality of positions can comprise a forward position (FIG. 12) and a rearward position (FIG. 13) that are spaced at least one inch, or at least two inches, or at least three inches along an anteroposterior adjustment axis 90. Optionally, the position of the hood 130 can be selectively and repeatedly adjustable or movable between the forward position and the rear position. In various optional aspects, the plurality of positions can comprise an upper position and a lower position that is spaced from the upper position along a vertical axis by at least one inch, or at least two inches, or at least three inches.

In various aspects, the hood 130 and the head engagement element 102 can be coupled together with one or more hook and loop couplings, thereby allowing for fine adjustment between the head engagement element and the hood (as opposed to, for example, snaps, that have discrete spacing selections). It is contemplated that a minimum amount of hook and loop engagement can be desirable in order to ensure a secure coupling. Such minimum amount can optionally be about one square inch of engagement. It is further contemplated that, in order to be optimally adjustable, a limited amount of overlap of hook and loop in each position of the plurality of positions can be desirable to enable ease of separation between the hood 130 and the head engagement element 102. That is, the ease of separation can promote minor adjustments to achieve a proper fit. Accordingly, the disclosed embodiments can promote a properly fitted hood in contrast with conventional devices that are difficult to fit properly and are either left uncomfortably positioned or too loose, thereby compromising the fluid barrier between the hood and the wearer. It is further contemplated that a poor fit can lead to air leaking at the ear, which can be noisy.

Referring to FIGS. 10-13, in some aspects, the hood 130 can comprise, on each side, a forward hook material 140 that is positioned and otherwise configured to couple to a respective forward loop material 142 of the head engagement device 102. Optionally, the forward hook material 140 of the hood 130 can have dimensions that are about 3 inches in length (oriented along a vertical axis 92) and about 1.5 inches in width (extending along the anteroposterior adjustment axis). Optionally, the forward loop material 142 of the head engagement device 102 can have dimensions of about 2 inches (extending along the anteroposterior adjustment axis) by about 1.5 inches (extending vertically). Accordingly, this configuration can enable vertical movement of about two inches while still providing sufficient engagement (e.g., a linear inch of overlap) between the hook material 140 and loop material 142. In exemplary, optional aspects, the loop materials 142 can be longitudinally spaced from each other by from about 5 inches to about 8 inches, e.g., about 6 inches or about 6.5 inches.

The hood 130 can further comprise, on each side, a rear hook material 144 that is positioned and otherwise configured to couple to a respective rear loop material 146 of the head engagement device 102. Optionally, the rear hook material can have dimensions of about 2 inches (extending along the anteroposterior adjustment axis) by about 1.5 inches (extending vertically). Optionally, the rear loop material 146 of the head engagement device 102 can have dimensions of about 2 inches (extending along the anteroposterior adjustment axis) by about 1.5 inches (extending vertically). In this way, this configuration can enable movement along the anteroposterior adjustment axis 90 of about two inches while still providing sufficient engagement (e.g., a linear inch of overlap) between the hook material 144 and loop material 146. In exemplary, optional aspects, the loop materials 146 can be spaced from the respective adjacent the loop materials 142 by from about one inch to about two inches (e.g., about 1.5 inches). In exemplary, optional aspects, the loop material 146 closest to the hook material 118 can be spaced by from about 0.5 inches to about 1 inch (e.g., about ⅞ inch).

In exemplary, optional aspects, the loop material 146 closest to the loop material 116 (and the first end 112) can be spaced from the first end 112 by about 4 inches to about 7 inches, e.g., about 4⅝ inches.

The hook and loop dimensions can be selected based on testing on NIOSH headforms, which represent the facial size and shape distribution of current U.S. respirator users. It is contemplated that the forward hook material 140 and the forward loop material 142 can generally be configured to enable vertical positioning of the hood to allow the rim to bias against the underside of the chin of the wearer and extend above the ears of the wearer. Likewise, the rear hook material 144 and the rear loop material 146 can be configured to allow positioning the rim 134 along the anteroposterior adjustment axis. In this way, the hood can be adjusted to properly fit (comfortably and sealingly) the dimensions of a wide variety of head shapes.

In exemplary optional aspects, it is further contemplated that each section of hook material can be configured to engage each loop material so that, for any given hook material and loop material segments, no more than three square inches, no more than 3.5 square inches, or no more than four square inches of hook material and loop material are in engagement. In this way, the hook and loop material can be sufficiently easily separated to promote proper adjustment between the hood 130 and the head engagement element 102.

In various aspects, the hook and loop materials can have a medium-high peel strength. Optionally, the peel strength can be at least 0.25 pounds per inch width, 0.5 pounds per inch width, or 1 pound per inch width. The hook and loop materials can be low profile to minimize intertwinement between the hair of the wearer and the hook and loop materials. The respirator assembly 100 can be used in fast-paced clinical settings, such as, for example, hospital emergency rooms, surgical settings, and during pandemic responses. Therefore, it can be desirable to minimize a number of adjustments. Accordingly, it can be desirable to achieve a proper fit and then remove and don and doff the coupled pair of the head engagement element 102 and the hood 130. This can reduce the number to cycles on the hook and loop material. Accordingly, low-cycle hook and loop material can be used.

In conventional PAPR hoods, an elongate member is selectively tightened (e.g., tied) to select the tension on the rim 134, corresponding to the force of the rim against the head of the wearer. In contrast, the respiratory device 100 of the present disclosure can comprise an elastic member 150 that extends along the rim of the hood. In this way, the rim can elastically bias against the head of the wearer to inhibit fluid transfer therebetween the rim and the head of the wearer. The elastic member 150 can optionally be, for example, 23 inches long when not under tension. Having a predetermined length of the elastic member 150 can prevent a user from over-loosening the fit of the rim, which can compromise the airflow barrier.

Further, the elongate member for tightening the rim against the head of the wearer used in conventional PAPR hoods cannot be disinfected. In contrast, referring to FIGS. 1 and 14, the elastic member 150 of the respiratory device 100 can be encased in a polymer cover 152. For example, the polymer cover can comprise an elongate strip of material that is folded along its longitudinal axis with its longitudinally extending edges meeting to define an elongate receptacle therein. The opposing longitudinally extending edges and ends of the elongate strip can be stitched together to seal the elastic member 150 within the elongate receptacle. The opposing ends of the elastic member 150 can be coupled to the hood 150 (e.g., via stitching) to retract the rim against the head of the wearer. The polymer cover 152 can prevent the elastic member 150 from absorbing and housing contaminants, thereby enabling the hood to be cleaned, sanitized, and reused. The polymer cover 152 can be coupled to a main hood portion 131 via stitching, adhesive, or other suitable attachment means so that the polymer cover 152 and elastic member 150 extend along the rim 130. In various further aspects, the elastic member 150 can comprise waterproof, stitchable/fusable cleanable elastic and, in these aspects, does not require a polymer cover 152.

It is contemplated that air supply hoses having various hose fittings are known used in the art. To enable the respirator device 100 to adaptably couple to multiple different types of hose fittings of the air supply hoses, the respiratory device 100 can comprise an interchangeable hose fitting 160. Referring to FIGS. 16-23, the interchangeable hose fitting 160 can comprise a hose adapter 162 having a first end 164 and an axially opposed second end 166. The hose adapter can have a cylindrical exterior surface 168 that extends from the first end. The hose adapter 162 can comprise a flange 170 at the first axial end. A radially extending projection 172 can be spaced from the first end 164 and can extend from the cylindrical exterior surface 168. The radially extending projection 172 can comprise a bayonet pin that can be integral to or inserted into a main body of the hose adapter 162. The second end 166 of the hose adapter 162 can be configured to be coupled to a corresponding hose fitting of an air supply hose.

The hood 130 can define a hole 174 through which the hose adapter 162 of the hose fitting extends. A locking sleeve 176 can retain the hose adapter 162 within the hole 174 of the hood 130. The locking sleeve 176 can comprise an annular body 178 having a rear end 179. The annular body 178 can define a cylindrical inner surface 182 that is configured to receive the cylindrical exterior surface 168 of the hose adapter 162.

The annular body 178 can define a slot 180 that is configured to receive the radially extending projection 172 of the hose adapter 162. The slot 180 can comprise a first end 182 that extends to the rear end of the annular body and a second end 184 that is rotationally offset from the first end. In this way, the radially extending projection 172 can be received within the first end, and the locking sleeve 176 can be rotated until the radially extending projection 172 is at the second end. The slot 180 can further define an axially extending lip 186 that is configured to retain the radially extending projection 172 between the axially extending lip 186 and the second end 184.

When the cylindrical exterior surface 168 of the hose adapter 162 is received within the cylindrical inner surface of the locking sleeve and the radially extending protrusion 172 of the hose adapter 162 is disposed within the slot 180 of the locking sleeve 176, the flange 170 of the hose adapter can bias against the inner surface 192 (FIG. 6) of the hood, and the rear end 179 of the annular body 178 of the locking sleeve 176 can bias against the outer surface 190 of the hood. The flange 170 of the hose adapter 162 can define radially extending recesses on opposing sides to assist with rotation of the hose adapter relative to the locking sleeve 176.

In this way, the hose fitting 160 can be adaptable to multiple hose couplings. It is further contemplated that the hose fitting 160 can be threadless and require a substantial amount of torque to decouple, thereby preventing inadvertent decoupling that can lead to a safety hazard. Further, no additional seals are required. Still further, the disclosed coupling can easily be disinfected.

Optionally, hose adapter 162 can comprise a plurality of radially extending protrusions 172 (e.g., 2 protrusions) that can optionally be circumferentially symmetrically spaced about a central axis. The locking sleeve 176 can define a respective slot 180 for each radially extending protrusion.

Optionally, a kit can comprise a locking sleeve and a plurality of hose adapters that are configured to couple to different hose fittings. The kit can further comprise a hood 130 and a head engagement element 102.

In some aspects, it is contemplated that the hood can comprise a material that is configured to be disinfected and reused. The material can be smooth to facilitate disinfection. For example, in various optional aspects, the hood 130 and, optionally, other portions of the respiratory device 100 (e.g., the head engagement element), can comprise metallocene that can optionally be 4 mils thick. It is contemplated that the material (e.g., 4-mil-thick metallocene) can advantageously have sufficient strength while being sufficiently malleable and flexible. The material can be non-textured to promote cleanability. The material can optionally be opaque. The material can optionally be colored to provide contrast with blood (e.g., green) as well as to be aesthetically pleasing. The material can comprise an antistatic additive to be usable with electronics and electronic components. It is further contemplated that the hood can be free of exterior folds or pockets that could accumulate contamination.

It is contemplated that the hood can be reused for at least 30 uses or at least 50 uses. It is further contemplated that the coupling 160 can last for hundreds or thousands of uses.

Although embodiments disclosed herein are generally directed to PAPR hoods, it is contemplated that the disclosed aspects can be applicable to various other respiratory devices. For example, aspects disclosed herein can be incorporated in firefighter respirators. Further applications can include shroud-style PAPRs, controlled air purifying respirators (CAPRs), or hoods in which the respirator is integral to the hood.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A respiratory device for covering a head of a wearer, the respiratory device comprising:

a head engagement element;

a hood defining an interior and a rim, wherein the rim is configured to bias against the head of the wearer to inhibit air communication therebetween, wherein at least a portion of the hood is transparent;

a hose fitting that is operatively coupled to the hood to provide air therethrough into the interior of the hood,

wherein the hood is configured to be releasably coupled to the head engagement element at a plurality of positions, the plurality of positions comprising a forward position and a rear position that is spaced from the forward position by at least one inch along an anteroposterior adjustment axis.

Aspect 2: The respiratory device of aspect 1, wherein the hood is configured to be releasably coupled to the head engagement element at a plurality of vertical positions, the plurality of vertical positions comprising an upper position and a lower position that is spaced from the upper position along a vertical axis by at least two inches.

Aspect 3: The respiratory device of aspect 1 or aspect 2, wherein the head engagement element comprises one of a hook material or a loop material, wherein the hood comprises the other of the hook material or the loop material.

Aspect 4: The respiratory device of aspect 3, wherein the hook material comprises at least one hook segment, wherein the loop material comprises at least one segment, wherein for each coupled pair of the at least one hook segment and the at least one loop segment, no more than three square inches of the at least one hook segment is configured to be coupled to the at least one loop.

Aspect 5: The respiratory device of any one of the preceding aspects, wherein the head engagement element is configured to be decoupled from the hood with less than one pound of force.

Aspect 6: The respiratory device of any one of the preceding aspects, wherein the hood is selectively and repeatedly positionable between the forward position and the rear position.

Aspect 7: The respiratory device of any one of the preceding aspects, wherein the head engagement element comprises a looped band.

Aspect 8: The respiratory device of aspect 7, wherein the looped band has a first end portion and a second end portion, wherein the looped band comprises at least one fastener that is configured to couple the first end portion to the second end portion.

Aspect 9: The respiratory device of aspect 8, wherein the at least one fastener is configured to couple the first end portion to the second end portion in a plurality of positions to permit user selection of an operative circumference of the looped band.

Aspect 10: The respiratory device of aspect 9, wherein the at least one fastener comprises hook material and loop material.

Aspect 11: The respiratory device of aspect 10, wherein the at least one of the hook material or the loop material is elongate along the operative circumference of the looped band to permit user selection of the operative circumference of the looped band.

Aspect 12: The respiratory device of aspect 10, wherein the at least one of the hook material or the loop material comprises a plurality of segments that are spaced along the operative circumference of the looped band.

Aspect 13: The respiratory device of any one of the preceding aspects, wherein the head engagement element comprises an elastic material.

Aspect 14: The respiratory device of any one of the preceding aspects, wherein the hood comprises a material that is configured to be disinfected and reused.

Aspect 15: The respiratory device of any one of the preceding aspects, wherein the rim is shaped to be positioned forward of ears of the wearer along the anteroposterior adjustment axis.

Aspect 16: The respiratory device of any one of the preceding aspects, wherein the hood comprises an elastic member that extends along the rim of the hood, wherein the elastic member is sealed within a polymer housing.

Aspect 17: The respiratory device of any one of the preceding aspects, wherein the hood defines a hole through which the hose fitting extends, wherein the hood defines an inner surface and an outer surface, wherein the hose fitting comprises:

a hose adapter having a first end and an axially opposed second end, the hose adapter comprising:
an inner bore extending between the first and second end;
a cylindrical exterior surface that extends from the first end;
a flange at the first end; and
a radially extending projection that is spaced from the first end and extends from the cylindrical exterior surface, wherein the second end of the hose adapter is configured to couple to a corresponding hose fitting of an air supply hose; and

a locking sleeve comprising:
an annular body having a rear end and a cylindrical inner surface that is configured to receive the cylindrical exterior surface of the hose adapter, wherein the annular body defines a slot therein, wherein the slot comprises:
   a first end that extends to the rear end of the annular body;
   a second end that is axially and rotationally offset from the first end; and
   an axially extending lip that is positioned between the first end and the second end,

wherein, with the cylindrical exterior surface of the hose adapter received within the cylindrical inner surface of the locking sleeve and the radially extending protrusion of the hose adapter extending into the slot of the locking sleeve, the flange of the hose adapter biases against the inner surface of the hood, and the rear end of the annular body biases against the outer surface of the hood.

Aspect 18: A respiratory device for covering a head of a wearer, the respiratory device comprising:

a hood defining an inner surface, an outer surface and an interior, wherein the hood is configured to bias against the head of the wearer to inhibit air communication therebetween;

a hose fitting that is operatively coupled to the hood to provide air therethrough into the interior of the hood, wherein the hood defines a hole through which the hose fitting extends, wherein the hose fitting comprises:
a hose adapter having a first end and an axially opposed second end, the hose adapter comprising:
   an inner bore extending between the first and second end;
   a cylindrical exterior surface that extends from the first end;
   a flange at the first end; and
   a radially extending projection that is spaced from the first end and extends from the cylindrical exterior surface,
   wherein the second end of the hose adapter is configured to couple to a corresponding hose fitting of an air supply hose; and
a locking sleeve comprising:
   an annular body having a rear end and a cylindrical inner surface that is configured to receive the cylindrical exterior surface of the hose adapter, wherein the annular body defines a slot therein, wherein the slot comprises:
      a first end that extends to the forward end of the hollow axial protrusion;
      a second end that is axially and rotationally offset from the first end; and
      an axially extending lip that is positioned between the first end and the second end,
wherein, with the cylindrical exterior surface of the hose adapter received within the cylindrical inner surface of the locking sleeve and the radially extending protrusion of the hose adapter extending into the slot of the locking sleeve, the flange of the hose adapter biases against the inner surface of the hood, and the rear end of the annular body biases against the outer surface of the hood.

Aspect 19: The respiratory device of aspect 14, further comprising a head engagement element, wherein the hood is configured to be releasably coupled to the head engagement element.

Aspect 20: A respiratory device for covering a head of a wearer, the respiratory device comprising:

a head engagement element;

a hood defining an interior, wherein the hood is configured to bias against the head of the wearer to inhibit air communication therebetween, wherein at least a portion of the hood is transparent;

a hose fitting that is operatively coupled to the hood to provide air therethrough into the interior of the hood,

wherein the hood comprises a material that is configured to be disinfected and reused,

wherein the hood comprises an elastic member that extends along the rim of the hood, wherein the elastic member is fully sealed within a polymer housing.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A respiratory device for covering a head of a wearer, the respiratory device comprising:
a head engagement element;
a hood defining an interior and a rim, wherein the rim is configured to bias against the head of the wearer to inhibit air communication therebetween, wherein at least a portion of the hood is transparent;
a hose fitting that is operatively coupled to the hood to provide air therethrough into the interior of the hood,
wherein the hood is configured to be releasably coupled to the head engagement element at a plurality of positions, the plurality of positions comprising a forward position and a rear position that is spaced from the forward position by at least one inch along an anteroposterior adjustment axis.

2. The respiratory device of claim 1, wherein the hood is configured to be releasably coupled to the head engagement element at a plurality of vertical positions, the plurality of vertical positions comprising an upper position and a lower position that is spaced from the upper position along a vertical axis by at least two inches.

3. The respiratory device of claim 1, wherein the head engagement element comprises one of a hook material or a loop material, wherein the hood comprises the other of the hook material or the loop material.

4. The respiratory device of claim 3, wherein the hook material comprises at least one hook segment, wherein the loop material comprises at least one segment, wherein for each coupled pair of the at least one hook segment and the at least one loop segment, no more than three square inches of the at least one hook segment is configured to be coupled to the at least one loop.

5. The respiratory device of claim 1, wherein the head engagement element is configured to be decoupled from the hood with less than one pound of force.

6. The respiratory device of claim 1, wherein the hood is selectively and repeatedly positionable between the forward position and the rear position.

7. The respiratory device of claim 1, wherein the head engagement element comprises a looped band.

8. The respiratory device of claim 7, wherein the looped band has a first end portion and a second end portion, wherein the looped band comprises at least one fastener that is configured to couple the first end portion to the second end portion.

9. The respiratory device of claim 8, wherein the at least one fastener is configured to couple the first end portion to the second end portion in a plurality of positions to permit user selection of an operative circumference of the looped band.

10. The respiratory device of claim 9, wherein the at least one fastener comprises hook material and loop material.

11. The respiratory device of claim 10, wherein the at least one of the hook material or the loop material is elongate along the operative circumference of the looped band to permit user selection of the operative circumference of the looped band.

12. The respiratory device of claim 10, wherein the at least one of the hook material or the loop material comprises a plurality of segments that are spaced along the operative circumference of the looped band.

13. The respiratory device of claim 1, wherein the head engagement element comprises an elastic material.

14. The respiratory device of claim 1, wherein the hood comprises a material that is configured to be disinfected and reused.

15. The respiratory device of claim 1, wherein the rim is shaped to be positioned forward of ears of the wearer along the anteroposterior adjustment axis.

16. The respiratory device of claim 1, wherein the hood comprises an elastic member that extends along the rim of the hood, wherein the elastic member is sealed within a polymer housing.

17. The respiratory device of claim 1, wherein the hood defines a hole through which the hose fitting extends, wherein the hood defines an inner surface and an outer surface, wherein the hose fitting comprises:
a hose adapter having a first end and an axially opposed second end, the hose adapter comprising:
an inner bore extending between the first and second end;
a cylindrical exterior surface that extends from the first end;
a flange at the first end; and
a radially extending projection that is spaced from the first end and extends from the cylindrical exterior surface,
wherein the second end of the hose adapter is configured to couple to a corresponding hose fitting of an air supply hose; and
a locking sleeve comprising:
an annular body having a rear end and a cylindrical inner surface that is configured to receive the cylindrical exterior surface of the hose adapter, wherein the annular body defines a slot therein, wherein the slot comprises:
a first end that extends to the rear end of the annular body;
a second end that is axially and rotationally offset from the first end; and
an axially extending lip that is positioned between the first end and the second end,
wherein, with the cylindrical exterior surface of the hose adapter received within the cylindrical inner surface of the locking sleeve and the radially extending protrusion of the hose adapter extending into the slot of the locking sleeve, the flange of the hose adapter biases against the inner surface of the hood, and the rear end of the annular body biases against the outer surface of the hood.

18. A respiratory device for covering a head of a wearer, the respiratory device comprising:
a hood defining an inner surface, an outer surface and an interior, wherein the hood is configured to bias against the head of the wearer to inhibit air communication therebetween;
a hose fitting that is operatively coupled to the hood to provide air therethrough into the interior of the hood,
wherein the hood defines a hole through which the hose fitting extends, wherein the hose fitting comprises:
a hose adapter having a first end and an axially opposed second end, the hose adapter comprising:
an inner bore extending between the first and second end;
a cylindrical exterior surface that extends from the first end;
a flange at the first end; and
a radially extending projection that is spaced from the first end and extends from the cylindrical exterior surface,
wherein the second end of the hose adapter is configured to couple to a corresponding hose fitting of an air supply hose; and
a locking sleeve comprising:
an annular body having a rear end and a cylindrical inner surface that is configured to receive the cylindrical exterior surface of the hose adapter, wherein the annular body defines a slot therein, wherein the slot comprises:
a first end that extends to the forward end of the hollow axial protrusion;
a second end that is axially and rotationally offset from the first end; and
an axially extending lip that is positioned between the first end and the second end,
wherein, with the cylindrical exterior surface of the hose adapter received within the cylindrical inner surface of the locking sleeve and the radially extending protrusion of the hose adapter extending into the slot of the locking sleeve, the flange of the hose adapter biases against the inner surface of the hood, and the rear end of the annular body biases against the outer surface of the hood.

19. The respiratory device of claim 18, further comprising a head engagement element, wherein the hood is configured to be releasably coupled to the head engagement element.

20. A respiratory device for covering a head of a wearer, the respiratory device comprising:
a head engagement element;
a hood defining an interior, wherein the hood is configured to bias against the head of the wearer to inhibit air communication therebetween, wherein at least a portion of the hood is transparent;
a hose fitting that is operatively coupled to the hood to provide air therethrough into the interior of the hood,
wherein the hood comprises a material that is configured to be disinfected and reused,
wherein the hood comprises an elastic member that extends along the rim of the hood, wherein the elastic member is fully sealed within a polymer housing.
